(19) United States
(12) Patent Application Publication
(10) Pub. No.: US 2026/0009459 A1
(43) Pub. Date: Jan. 8, 2026

(54) STRAIN WAVE GEAR

(71) Applicant: Minebea Mitsumi, lnc., Nagano (JP)

(72) Inventors: Sergej Solovev, Villing-Schwenningen (DE); Jurgen Schill, Bad Durrheim (DE); Vladimir Popov, Villing-Schwenningen (DE)

(21) Appl. No.: 18/766,420

(22) Filed: Jul. 8, 2024

(51) Int. Cl. F16H 49/00; F16C 9/04; F16C 19/38; F16C 33/34; F16C 33/58; F16C 33/72

(52) U.S. Cl. CPC F16H 49/001; F16C 9/04; F16C 19/386; F16C 33/34; F16C 33/581; F16C 33/72

(57) ABSTRACT

There is provided a strain wave gear including a drive shaft and an output shaft, a flexible external gear wheel connected to the drive shaft and a rigid internal gear wheel connected to the output shaft, a wave generator that engages the flexible external gear wheel from radially inward to establish a partial engagement with the rigid internal gear wheel over a circumference of the flexible external gear wheel and to move the partial engagement in the circumferential direction. The output shaft is supported coaxially to the drive shaft, and the output shaft is relatively supported axially outside the partial engagement on the drive shaft.

### FIELD OF THE INVENTION

The present invention relates to a strain wave gear. Such a strain wave gear can be used in particular in an actuator for a robot.

### BACKGROUND

Strain wave gears (SWG), also referred to as harmonic drives, are used in drive trains to produce a very high reduction ratio and are characterized by their compact design. For example, a strain wave gear such as the one to which the present invention can be used as an actuator in a robot, for example to drive a robot arm.

A strain wave gear is disclosed, for example, in DE 60 2005 001 131 T2.

Another generic strain wave gear is shown in an axial section in FIG. 1. This comprises a drive shaft 1 and an output shaft 2, each of which is supported in a housing 13 by roller bearings. The drive shaft 1 is supported in the housing 13 by two drive shaft roller bearings 14.1 and 14.2 in the region of a drive side 6 of the strain wave gear and the output shaft 2 is also supported in the region of the drive side 6 by a cross roller bearing 18 in the housing 13. The drive side 6 is provided on a first axial side of the drive connection between the drive shaft 1 and the output shaft 2, which will be described below, whereas the output side 7 is provided on the other axial side of this drive connection. The drive shaft 1 carries the rotor 17.1 of an electric motor 17. The stator 17.2 of the electric motor 17 is supported in the housing 13.

To support the output shaft 2 in the housing 13, a ring 19 is connected to a flange 16 of the output shaft 2 in the axial direction. The housing 13 also contains a holder 20 for the cross roller bearing 18, which is made up of several parts. The cross roller bearing 18 is accordingly positioned radially between the holder 20 and the ring 19 and positioned at a comparatively large axial distance from the output-side axial end 2.1 of the output shaft 2.

The drive connection between the drive shaft 1 and the output shaft 2 comprises a flexible external gear wheel 3, a rigid internal gear wheel 4 and a wave generator 5, which engages the flexible external gear wheel 3 from radially inward to establish a partial engagement with the rigid internal gear wheel 4 over a circumference of the external gear 3 and to move the partial engagement in the circumferential direction about the common axis of rotation 21 of the drive shaft 1 and the output shaft 2.

A disadvantage of the embodiment shown is the long tolerance chain between the cross roller bearing 18 and the output shaft 2, in particular the output-side axial end 2.1 of the output shaft 2. If, for example, the housing 13 is held at the housing connection 23 on the drive side 6 and the drive shaft 1 and output shaft 2 are supported exclusively in the housing 13, this leads in practice to the output shaft being inclined relative to the drive shaft and periodically increased friction being generated in the strain wave gear. Such periodically increased friction can manifest itself in the form of a sine wave during torque transmission with the strain wave gear, which sine wave is disadvantageous and must be filtered out in some applications, for example if a sensor is provided for torque.

Furthermore, in particular when used in an actuator for a robot, very high tolerance requirements are placed on the strain wave gear, wherein only extremely small tolerances are permissible.

### SUMMARY

The present invention is based on the object of improving the strain wave gear shown in FIG. 1 in such a way that tolerances can be minimized and the disadvantageous generation of friction is prevented.

The object according to the invention is achieved by a strain wave gear having the features of claim 1. The dependent claims describe advantageous and particularly useful embodiments of the invention.

A strain wave gear according to the invention has a drive shaft and an output shaft. A flexible external gear wheel is connected to the drive shaft. A rigid internal gear wheel is connected to the output shaft, wherein the internal gear wheel can be designed as a single piece with the output shaft or can be connected thereto, in particular with a flange screw connection.

Furthermore, a wave generator is provided that engages the flexible external gear wheel from radially inward to establish a partial engagement with the rigid internal gear wheel over a circumference of the external gear wheel and to move the partial engagement in the circumferential direction. The output shaft is supported coaxially to the drive shaft.

According to the invention, the output shaft is mounted axially outside the partial engagement on the drive shaft.

The relative bearing arrangement according to the invention reliably prevents the output shaft from tilting during operation.

In particular, the drive shaft extends axially from a drive side of the strain wave gear, which drive side is positioned axially next to the partial engagement on a first side, to an output side of the strain wave gear, which output side is positioned axially next to the partial engagement on a second side facing away from the first side. This allows the output shaft to be relatively supported on the drive shaft by a bearing, preferably a roller bearing, on the output side.

Accordingly, the distance between the bearing and the output-side axial end of the output shaft is in particularly small, which results in low tilting moments.

In particular, the bearing, which is preferably designed as a roller bearing, has at least two rows. This allows tipping moments to be absorbed particularly effectively. For example, the bearing has an X-arrangement or an O-arrangement.

Particularly preferably, the bearing comprises a fixed bearing and a floating bearing, wherein the fixed bearing is arranged in particular on the side of the floating bearing axially facing away from the partial engagement. Thus, the fixed bearing can form the axially outer row of the two bearing rows and the floating bearing can form the axially inner row of the two bearing rows. This keeps the output shaft particularly stable against unwanted displacement on the drive shaft.

Preferably, the bearing inner rings or bearing outer rings of the two bearing rows, in particular the fixed bearing and the floating bearing, are elastically clamped against each other in the axial direction. The other rings can preferably be held rigidly relative to each other with a spacer.

The output shaft is preferably supported exclusively by the relative bearing arrangement, i.e., the strain wave gear is free from any further bearing arrangement of the output shaft outside of the relative bearing arrangement on the drive shaft. This allows for a compact design and the desired low tolerances on the output shaft can be achieved particularly reliably.

The wave generator preferably has an elliptical disk arranged on the drive shaft and a roller bearing via which the elliptical disk elastically deforms the external gear wheel to produce the partial engagement when rotating about the common axis of rotation of the drive shaft and the output shaft. The elliptical disk can be connected to the drive shaft as a separate component or can be integral with the drive shaft.

Preferably, the roller bearing of the wave generator has a flexible outer ring, and an inner ring of the roller bearing is formed by the elliptical disk. According to an alternative embodiment, the roller bearing has a flexible inner ring and a flexible outer ring, both of which are deformed by the elliptical disk as it rotates.

According to an advantageous embodiment of the invention, the strain wave gear comprises a housing in which the drive shaft is supported, in particular by means of drive shaft roller bearings. The output shaft is preferably free of any bearing arrangement in this housing.

Particularly preferably, the output shaft is sealed against the housing with a seal, in particular a radial seal. For example, the output shaft forms a bell with components axially connected to a flange of the output shaft, which bell accommodates an axial end of the drive shaft and the wave generator. However, the output shaft can also form a bell in one piece.

Preferably, the drive shaft is at least substantially cylindrical or stepped cylindrical, and the output shaft is substantially hollow cylindrical with the axially connected flange.

In particular when used in an actuator of a robot, it is advantageous if a rotor of an electric motor is arranged on the drive shaft and a stator of the electric motor is arranged in the housing. For example, the rotor comprises permanent magnets and the housing carries windings of the electric motor. This allows the drive shaft to be driven electrically using the electric motor.

According to an advantageous embodiment, a brake is provided for the drive shaft, with which the drive shaft can be braked and/or locked. The brake can, for example, be designed as an electromagnetic brake and/or a permanent magnet brake.

Preferably, the brake is controlled in such a way that it brakes the drive shaft in the de-energized state.

An actuator according to the invention, which is in particular a component of a robot, for example a robot arm, comprises a strain wave gear of the embodiment according to the invention shown here.

The invention will be described below with reference to an embodiment and the figure by way of example.

### DESCRIPTION OF THE DRAWINGS

In the drawings:

FIG. 1 shows a strain wave gear according to the prior art;

FIG. 2 shows an exemplary embodiment of a strain wave gear according to the invention.

### DETAILED DESCRIPTION

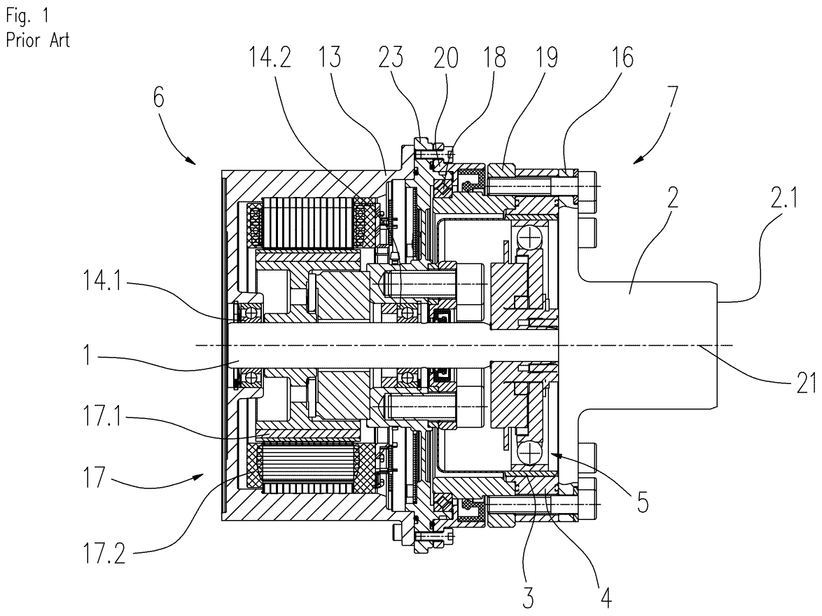

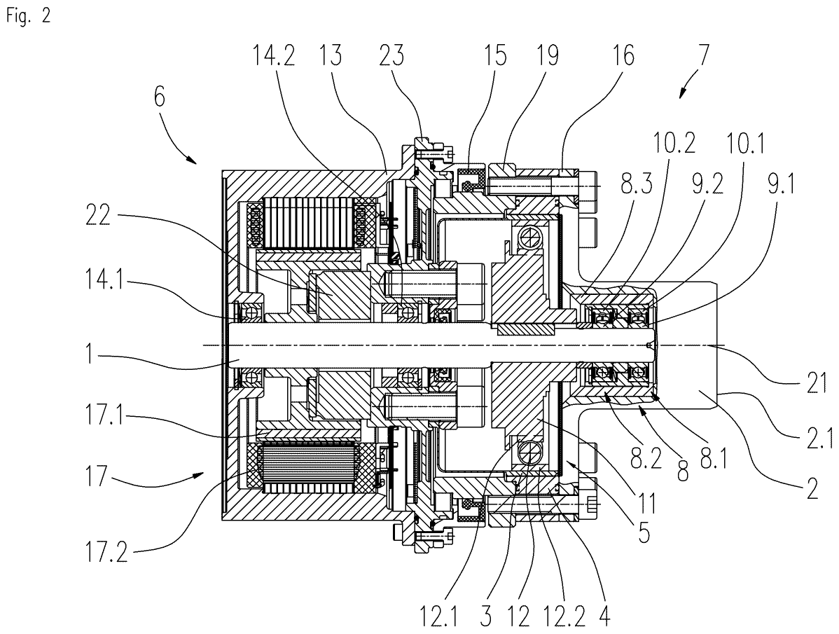

FIG. 2 shows an exemplary embodiment of a strain wave gear according to the invention in an axial section through the drive shaft 1 and the output shaft 2 as well as the housing 13, wherein the corresponding components are designated with the same reference signs as in FIG. 1. In this respect, reference is made to the description of FIG. 1.

The drive shaft 1 carries an elliptical disk 11 of the wave generator 5. A roller bearing 12 is arranged on the elliptical disk 11, wherein the rolling elements roll on the radially outer circumference of the elliptical disk 11. The elliptical disk 11 therefore forms an inner ring of the roller bearing 12.

Alternatively, as indicated by the dashed line, a flexible inner ring 12.1 could be provided, which is deformed by the elliptical disk 11 as it rotates.

The rolling elements roll radially on the outside of the flexible outer ring 12.2, whereby the flexible outer ring 12.2 and the flexible external gear wheel 3 lying radially on the outside thereof are periodically deformed. The external gear wheel 3 in turn meshes with the internal gear wheel 4, which is designed as a rigid ring, wherein only a partial engagement is formed between the flexible external gear wheel 3 and the rigid internal gear wheel 4, which partial engagement is moved by the rotation of the elliptical disk 11 in the circumferential direction around the common axis of rotation 21 of the drive shaft 1 and the output shaft 2.

The drive side 6 extends from the axially outer end of the drive shaft 1 in the axial direction along the axis of rotation 21 to said partial engagement, i.e., to a plane extending perpendicular to the axis of rotation 21, in which plane the external gear wheel 3, the roller bearing 12 and the internal gear wheel 4 are positioned. The output side 7 extends from there to the output-side axial end 2.1 of the output shaft 2.

The housing 13 is mounted, for example, in the region of the drive side 6 having the housing connection 23 on a component supporting the housing 13.

According to the invention, the output shaft 2 is relatively supported on the drive shaft 1 by means of a bearing 8, preferably, as shown here, in the region of the output side 7 of the strain wave gear.

The drive shaft 1 is supported by drive shaft roller bearings 14.1 and 14.2 in the region of the drive side 6 in the housing 13.

The bearing 8 is preferably designed as a roller bearing, in particular a double-row roller bearing, wherein the two rows of bearings can be accommodated, for example, in a common bearing housing 8.3 that is mounted radially inside or formed by the output shaft 2.

In the exemplary embodiment shown, the bearing 8 comprises a fixed bearing 8.1 and a floating bearing 8.2, each having a bearing inner ring 9.1, 9.2 and a bearing outer ring 10.1, 10.2. The bearing inner rings 9.1, 9.2 are rigidly supported against each other in the axial direction by means of a spacer. The bearing outer rings 10.1, 10.2 are preferably supported against each other in the axial direction via a spring-elastic element.

The fixed bearing 8.1 is preferably positioned axially outside the floating bearing 8.2, i.e., close to the output-side axial end 2.1 of the output shaft 2.

As in FIG. 1, a ring 19 is connected to the flange 16 of the output shaft 2. The internal gear wheel 4 is clamped between the flange 16 and the ring 19. The ring 19 is sealed against the housing 13 by means of a radial seal 15.

An electric motor 17 is arranged on the drive shaft 1, with which the drive shaft 1 can be driven. The electric motor 17 comprises a rotor 17.1 having permanent magnets and a stator 17.2 in the housing 13, in particular having a winding.

Furthermore, a brake 22 is arranged on the drive shaft 1, with which the drive shaft 1 can be braked and/or locked. The brake 22 is designed, for example, as a permanent magnet brake.

Preferably, the brake 22 is controlled in such a way that it brakes the drive shaft 1 in the de-energized state.

### LIST OF REFERENCE SIGNS

1 drive shaft
2 output shaft
2.1 output-side axial end
3 flexible external gear wheel
4 rigid internal gear wheel
5 wave generator
6 drive side
7 output side
8 bearing
8.1 fixed bearing
8.2 floating bearing
8.3 bearing housing
9.1 bearing inner ring
9.2 bearing inner ring
10.1 bearing outer ring
10.2 bearing outer ring
11 elliptical disk
12 roller bearing
12.1 inner ring
12.2 outer ring
13 housing
14.1 drive shaft roller bearings
14.2 drive shaft roller bearings
15 radial seal
16 flange
17 electric motor
17.1 rotor
17.2 stator
18 cross roller bearing
19 ring
20 holder
21 axis of rotation
22 brake
23 housing connection

1-17. (canceled)

18. A strain wave gear comprising:
a drive shaft and an output shaft;
a flexible external gear wheel connected to the drive shaft and a rigid internal gear wheel connected to the output shaft; and
a wave generator that engages the flexible external gear wheel from a radially inward direction of the flexible external gear wheel, to establish a partial engagement of the flexible external gear wheel with the rigid internal gear wheel over a circumference of the flexible external gear wheel and to move the partial engagement in a circumferential direction;
wherein the output shaft is supported coaxially by the drive shaft using a bearing arrangement axially outside the partial engagement on the drive shaft.

19. The strain wave gear according to claim 18, wherein the drive shaft extends axially from a drive side of the strain wave gear, the drive side is positioned axially next to the partial engagement on a first side, to an output side of the strain wave gear, the output side is positioned axially next to the partial engagement on a second side facing away from the first side, and the output shaft is supported on the drive shaft using the bearing arrangement on the output side.

20. The strain wave gear according to claim 18, wherein the output shaft is supported on the drive shaft using the bearing arrangement designed as a roller bearing.

21. The strain wave gear according to claim 20, wherein the bearing arrangement has at least two rows.

22. The strain wave gear according to claim 21, wherein the bearing arrangement has an X-arrangement.

23. The strain wave gear according to claim 21, wherein the bearing arrangement has an O-arrangement.

24. The strain wave gear according to claim 21, wherein the bearing arrangement comprises a fixed bearing and a floating bearing, wherein the fixed bearing is arranged on a side of the floating bearing axially facing away from the partial engagement.

25. The strain wave gear according to claim 24, wherein bearing inner rings or bearing outer rings of the at least two rows of the bearing arrangement are elastically clamped against one another in an axial direction.

26. (canceled)

27. The strain wave gear according to claim 18, wherein the wave generator comprises an elliptical disk arranged on the drive shaft and a roller bearing via which the elliptical disk deforms the external gear wheel to produce the partial engagement when rotating about a common axis of rotation of the drive shaft and the output shaft.

28. The strain wave gear according to claim 27, wherein the roller bearing has a flexible outer ring and an inner ring is formed by the elliptical disk, or the roller bearing has a flexible inner ring and a flexible outer ring.

29. The strain wave gear according to claim 18, wherein the strain wave gear comprises a housing in which the drive shaft is mounted.

30. The strain wave gear according to claim 29, wherein the output shaft is free from a bearing in the housing.

31. The strain wave gear according to claim 29, wherein the output shaft is sealed against the housing with a seal.

32. The strain wave gear according to claim 29, wherein a rotor of an electric motor is arranged on the drive shaft, and a stator of the electric motor is arranged in the housing.

33. The strain wave gear according to claim 18, wherein the drive shaft is at least substantially cylindrical or stepped cylindrical, and the output shaft is at least substantially hollow cylindrical with a connected flange.

34. An actuator comprising:
a strain wave gear including:
a drive shaft and an output shaft;
a flexible external gear wheel connected to the drive shaft and a rigid internal gear wheel connected to the output shaft; and
a wave generator that engages the flexible external gear wheel from a radially inward direction of the flexible external gear wheel, to establish a partial engagement of the flexible external gear wheel with the rigid internal gear wheel over a circumference of the flexible external gear wheel and to move the partial engagement in a circumferential direction;
wherein the output shaft is supported coaxially by the drive shaft using a bearing arrangement axially outside the partial engagement on the drive shaft.

35. The actuator according to claim 34, wherein the actuator is part of a robot.

36. The actuator according to claim 34, wherein the drive shaft extends axially from a drive side of the strain wave gear, the drive side is positioned axially next to the partial engagement on a first side, to an output side of the strain wave gear, the output side is positioned axially next to the partial engagement on a second side facing away from the first side, and the output shaft is exclusively supported on the drive shaft using the bearing arrangement on the output side.

37. The actuator according to claim 34, wherein the output shaft is supported on the drive shaft using the bearing arrangement designed as a roller bearing.
